(19) United States
(12) Patent Application Publication
(10) Pub. No.: US 2010/0327767 A1
(43) Pub. Date: Dec. 30, 2010

(54) SYSTEM AND METHOD FOR LED LAMPSTRING

(75) Inventor: Thomas Fay, Rye Brook, NY (US)

Correspondence Address: VENABLE LLP, P.O. BOX 34385, WASHINGTON, DC, 20043-9998, US

(73) Assignee: TPR Enterprises, Ltd., Mamaroneck, NY (US)

(21) Appl. No.: 12/492,523

(22) Filed: Jun. 26, 2009

(51) Int. Cl. H05B 37/02; H05B 41/36; H01J 9/00

(52) U.S. Cl. 315/294; 315/291; 445/23

(57) ABSTRACT

A light emitting diode (LED) lamp includes a base; an LED fixed to the base; an integrated circuit providing constant current or voltage control to the LED; and connectors for coupling one or more wires conducting electricity to the integrated circuit. The base may include holes to facilitate mounting thereof to an external surface. The respective sides of the base may be rounded in shape. The sides of the base may be of an electrically non-conductive material. The LED may be a long LED; a short LED; a frosted LED; a RBG LED; or a single color LED. The LED may be a through hole LED or a surface mounted LED. The LED may be a surface mounted LED or a lens. The lens may include the shape of at least one of: a circle; a star; a triangle; a square; or a bullet.

### BACKGROUND OF THE INVENTION

1. Field of the Invention

The present invention generally relates to light emitting diode (LED) lamps for use in decorative lighting or illumination, and more particularly relates to LED lamps which may be combined as a light string.

2. Description of Related Art

An LED light string has a number of discrete LED lamps strung together in series or parallel, and may cover the full color spectrum (RGB).

The LED light strings can be attached to a cloth, or other media such as thin walls, plastic sheets via hook and loop (such as Velcro®) fasteners, or combined with a drop curtain to present textile backdrops. The LED light strings can have high brightness that is suitable in both dark environments and well-lit spaces.

However, spacing among conventional LED light strings cannot be adjusted, and the lamps may not be designed to allow the mounting of LED light strings onto fabric or hard surfaces. Conventional LED light strings do not allow for various combination of LEDs

such as frosted LEDs, Long LEDs, short LEDs, and RGB LEDs.

### BRIEF DESCRIPTION OF THE DRAWINGS

The foregoing, as well as additional objects, features and advantages of the invention will be more readily apparent from the following detailed description, which proceeds with reference to the accompanying drawings.

The present invention will be discussed in more detail below, using a number of exemplary embodiments, with reference to the attached drawings, in which:

FIG. 1 is an exemplary embodiment of an elevated front perspective view of a single color LED lamp;

FIG. 2 is an exemplary embodiment of a side view of a single color LED lamp;

FIG. 3 is another exemplary embodiment of an elevated front prospective view of a single color LED lamp;

FIG. 4 is another exemplary embodiment of a side view of a single color LED lamp;

FIG. 5 is an exemplary embodiment of a top view of a single color LED lamp;

FIG. 6 is an exemplary embodiment of a bottom view of a single color LED lamp;

FIG. 7 is an exemplary embodiment of an elevated bottom view of a single color LED lamp;

FIG. 8 is an exemplary embodiment of several single color LED lamps connected together;

FIG. 9 is an exemplary embodiment of an elevated front perspective view of a multiple color LED lamp;

FIG. 10 is an exemplary embodiment of a side view of a multiple color LED lamp;

FIG. 11 is another exemplary embodiment of an elevated front prospective view of a multiple color LED lamp;

FIG. 12 is another exemplary embodiment of a side view of a multiple color LED lamp;

FIG. 13 is an exemplary embodiment of a top view of a multiple color LED lamp;

FIG. 14 is an exemplary embodiment of a bottom view of a multiple color LED lamp;

FIG. 15 is an exemplary embodiment of an elevated bottom view of a multiple color LED lamp;

FIG. 16 is an exemplary embodiment of several multiple color LED lamps connected together;

FIG. 17 is a exemplary embodiment of a star shaped lens;

FIG. 18 is a exemplary embodiment of a circle shaped lens;

FIG. 19 is a exemplary embodiment of a triangle shaped lens;

FIG. 20 is a exemplary embodiment of a square shaped lens; and

FIG. 21 is a exemplary embodiment of a bullet shaped lens.

### SUMMARY OF THE INVENTION

In an exemplary embodiment, a light emitting diode (LED) lamp is provided, including: a base; an LED fixed to the base; an integrated circuit providing constant current or voltage control to the LED; and connectors for coupling one or more wires conducting electricity to the integrated circuit. The base may further include one or more holes to facilitate mounting thereof to an external surface. The respective sides of the base may be rounded in shape. One or more sides of the base may include an electrically non-conductive material.

In an exemplary embodiment, the light emitting diode (LED) lamp further includes a spacer adjusting the distance of the LED from the base. The LED may also include at least one of: a long LED; a short LED; a frosted LED; a RBG LED; or a single color LED.

In an exemplary embodiment, the LED includes at least one of a through hole LED or a surface mounted LED. Also, the LED may include a surface mounted LED and a lens. The lens of the light emitting diode (LED) lamp may also have the shape of at least one of: a circle; a star; a triangle; a square; or a bullet.

In an exemplary embodiment, the one or more holes may facilitate mounting of the device to an external surface including at least one of a glue hole or a screw hole. The base may further include one or more strain relief tie downs. The LED lamp may also include at least an anode RGB LED or a cathode RGB LED.

In an exemplary embodiment, the base of the light emitting diode (LED) lamp of may further include one or more sides with a black solder mask. The base may also further include one or more sides with a user specified color. In an exemplary embodiment, the connectors for coupling the one or more wires may further include a groove designed to displace the insulation of a wire and provide an electrical connection.

In an exemplary embodiment, the connectors for coupling the one or more wires may further include one or more pins which will accept an interface with one or more sockets and provide an electrical connection. The a mounting position of the LED lamp on the one or more wires may be determined based on an adjustable spacing between a plurality of the LED lamps. Also, the base may further include one or more sides of the base being coated with an adhesive to facilitate mounting of the LED lamp to an external surface or material.

In an exemplary embodiment, a light emitting diode (LED) lamp string with one or more integrally mounted LED lamps is provided, the string including a plurality of LED lamps with adjustable spacing, each of the LED lamps including: a base; an LED fixed to the base; an integrated circuit providing constant current or voltage control to the LED; and connectors for coupling one or more wires conducting electricity to the integrated circuit. The base may further include one or more holes to facilitate mounting to an external surface. Also, the adjustable spacing between the LED lamps may be based on a user specification.

In an exemplary embodiment, the base of the light emitting diode (LED) lamp string may further include one or more strain relief tie downs. The base may further include one or more of its sides being coated with an adhesive to facilitate mounting of the LED lamp to an external surface or material.

In an exemplary embodiment, a method for assembling a plurality of light emitting diode (LED) lamps to form an LED lamp string is provided, including: assembling a plurality of LED lamps with one or more wires affixed between them; positioning each of the LED lamps on the one or more wires based on an adjustable spacing between them, where each of the LED lamps may include a base with an affixed LED and an integrated circuit designed to regulate current or voltage to the LED. The adjustable spacing between the light emitting diode (LED) lamps may also be determined based on a user specification.

### DETAILED DESCRIPTION OF THE INVENTION

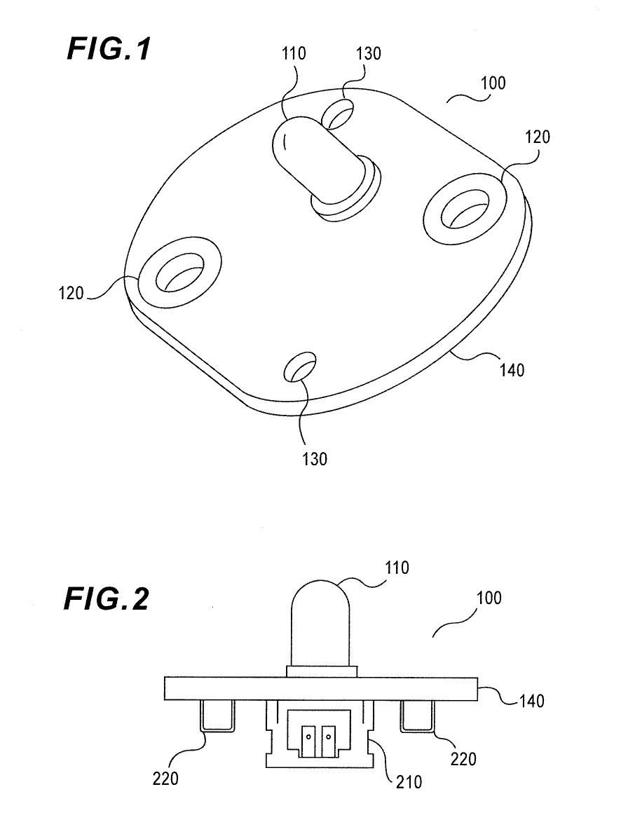

FIG. 1 depicts an exemplary embodiment of an elevated front perspective view of a single color LED lamp 100. In FIG. 1, an exemplary embodiment of LED 110 may be mounted on base 140. In one exemplary embodiment, an LED 110 may comprise, for example, a traditional LED, a frosted LED (e.g., provides a large viewing angle), a long LED (e.g., but not limited to 8.6 mm), a short LED (e.g., but not limited to 5.5 mm). In an exemplary embodiment, LED lamp 100 may display a single color, for example, but not limited to, red, green, blue, white, yellow, pink, orange, fuchsia, etc. Additionally, in an exemplary embodiment, LED 110 may be extended by a spacer (not shown) which increases the distance of LED 110 from base 140, and may allow, for example, mounting or displaying of the LED Lamp 100 in material too thick for an LED without a spacer.

FIG. 1 also depicts in an exemplary embodiment, base 140 may be a rounded printed circuit board with glue holes 130 and screw holes 120. In an exemplary embodiment, the rounded base 140 may be mounted on soft material (e.g., but not limited to, curtains or other fabric) (not shown) which may reduce the profile of the board 140 and may help prevent damage to soft mounting material (square boards with sharp edges may pierce through fabric after repeated folding and unfolding). In an exemplary embodiment, glue holes 130 may provide a method to mount base 140 using glue, tape, or other exemplary adhesive; glue holes 130 may provide better adhesion of base 140 to a mounting material. In an exemplary embodiment, screw holes 120 may provide a method to mount base 140 using screws or other exemplary fasteners to a mounting material. In an exemplary embodiment, screw holes 120 may provide grounding for the LED lamp 100. In an exemplary embodiment, base 140, may have no electrical conductivity on the side facing the mounting material to allow mounting to metal or other conductive surfaces without shorting. In an exemplary embodiment, in situations where the typical green circuit board color is not desirable, base 140 may have a black solder mask or other solder mask color to match the mounted material or for other color requirements.

FIG. 2 depicts an exemplary embodiment of a side view of a single color LED lamp 100. In FIG. 2, in an exemplary embodiment, an LED 110, two strain relief tie downs 220, and one mini plug-in connector 210 are shown mounted to base 140. In an exemplary embodiment, at least one mini plug-in connectors 210 may be mounted to base 140. In an exemplary embodiment, the mini plug-in connector 210 may be a commercial wire to board connector such as the Duraclik™, Mini Mi II™, or C-Grid III™ from Molex®. In an exemplary embodiment, the strain relief tie down 220 may provide additional wire support through the use of cable ties (not shown).

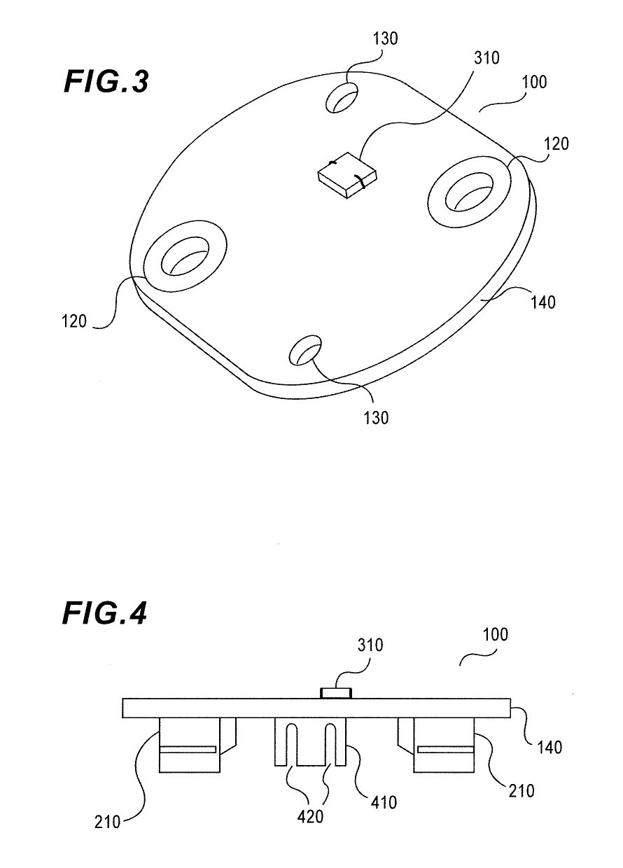

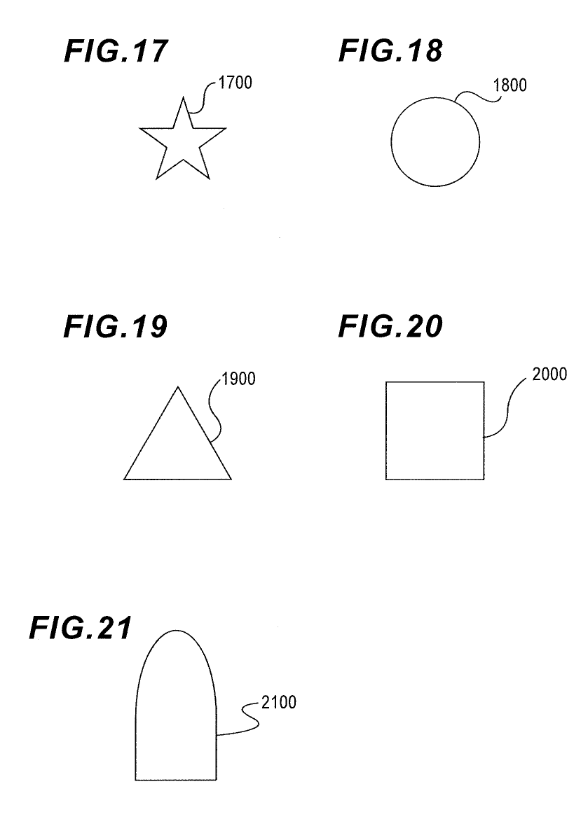

FIG. 3 is another exemplary embodiment of an elevated front prospective view of a single color LED lamp 100. In FIG. 3, an exemplary embodiment, LED 310 may be mounted on base 140. In one exemplary embodiment, LED 310 may use surface-mount technology to mount base 140. In FIG. 3, an exemplary embodiment of LED 310, is depicted that may use different lenses such as those depicted in the exemplary embodiments of FIGS. 17-21.

FIG. 4 is another exemplary embodiment of a side view of a single color LED lamp 100. In FIG. 4, in an exemplary embodiment, two mini plug-in connectors 210 and an insulation displacement connector (IDC) 410 are shown. In an exemplary embodiment, the IDC 410 and/or mini plug-in connectors 210, may allow an easy method for quickly connecting multiple LED lamps 100 to a power source. In an exemplary embodiment, IDC 410 may have grooves 420 for coupling conductor wires (e.g., but not limited to, 18 AWG stranded wires on 2.54 mm [0.100″] center lines) (not shown) with base 140. In an exemplary embodiment, the grooves 420 in IDC 410 may contain at least one edge 710 that may pierce the insulation of the conductor wires and may provide an electrical connection between the LED lamp 100 and the conductor wires.

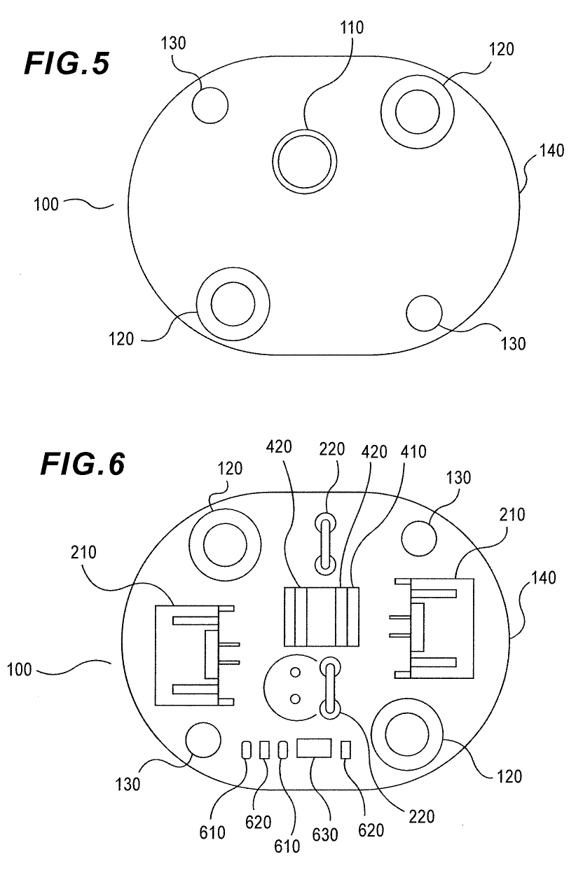

FIG. 5 is an exemplary embodiment of a top view of a single color LED lamp 100. In FIG. 5, exemplary embodiments of LED 110, base 140, screw holes 120, and glue holes 130 are shown.

FIG. 6 is an exemplary embodiment of a bottom view of a single color LED lamp 100. In FIG. 6, exemplary embodiments of IDC 410, mini plug-in connectors 210, strain relief tie downs 220, an integrated circuit 630, diodes 620, and resistors 610, may be mounted to base 140, which includes screw holes 120 and glue holes 130. In an exemplary embodiment, integrated circuit 630, diodes 620, and resistors 610, may protect the LED lamp 100 by providing constant current control in the event of a current or voltage spike and may prevent LED burnout if the polarity of the voltage is reversed.

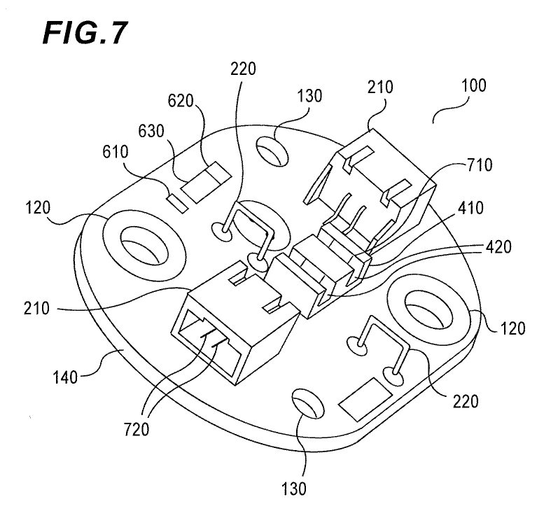

FIG. 7 is an exemplary embodiment of an elevated bottom view of a single color LED lamp 100. In FIG. 7, exemplary embodiments of IDC 410, mini plug-in connectors 210, strain relief tie downs 220, an integrated circuit 630, diodes 620, and resistors 610, may be mounted to base 140, which includes screw holes 120 and glue holes 130. In an exemplary embodiment, edge 710 may pierce the insulation of the conductor wire and may provide an electrical connection between the LED lamp 100 and the conductor wires. In another exemplary embodiment, an electrical connection may be formed by coupling the male pins 720 of mini plug-in connector 210 to a female connector (not shown) (e.g., but not limited to, a two-piece pin and socket interconnection). In an exemplary embodiment, the electrical connectors 720 may have simple positive and negative connections or they may have more complicated connections such as for ground, red, green, blue, and red.

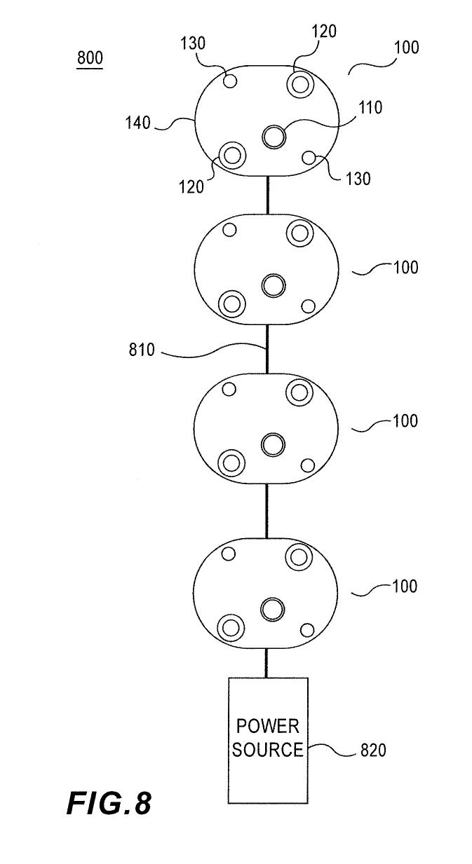

FIG. 8 illustrates an exemplary embodiment of an LED lamp string 800, which incorporates two or more of the aforementioned LED lamps 100 with an adjustable spacing therebetween. In an exemplary embodiment, the adjustable spacing between the LED lamps 100 may be set based on a user specification or input. In an exemplary embodiment, one end of the conductor wires 810 (e.g., but not limited to, 18 AWG stranded wires on 2.54 mm [0.100″] center lines) in the LED lamp string 800 may be capped for insulation, while the other end of the conductor wires 810 in the LED lamp string 800 may be mounted with a connector for electrical connection thereof to a power source 820. In an exemplary embodiment, LED lamp 100 may be coupled via conductor wires 810 with power source 820. In an exemplary embodiment, LED lamp 100 may connect to the conductor wires using the IDC 410 by placing the wires in grooves 420, whereby edge 710 may pierce the insulation of the conductor wires 810 and may provide an electrical connection to power source 820. In another exemplary embodiment, LED lamp 100 may connect to the conductor wires 810 using mini plug-in connector 210. In an exemplary embodiment, a mini plug-in connector 210 may be used as the input from a power source 820 and another mini plug-in connector 210, in the same LED lamp 100, may connect to a mini plug-in connector on another LED lamp 100 and thereby provide power. In an exemplary embodiment, an LED lamp string 800 may be manufactured by a method of assembling a plurality of LED lamps 100 with one or more wires 810 affixed therebetween through an IDC 410, a mini plug-in 210, another connector, or a combination of various connectors.

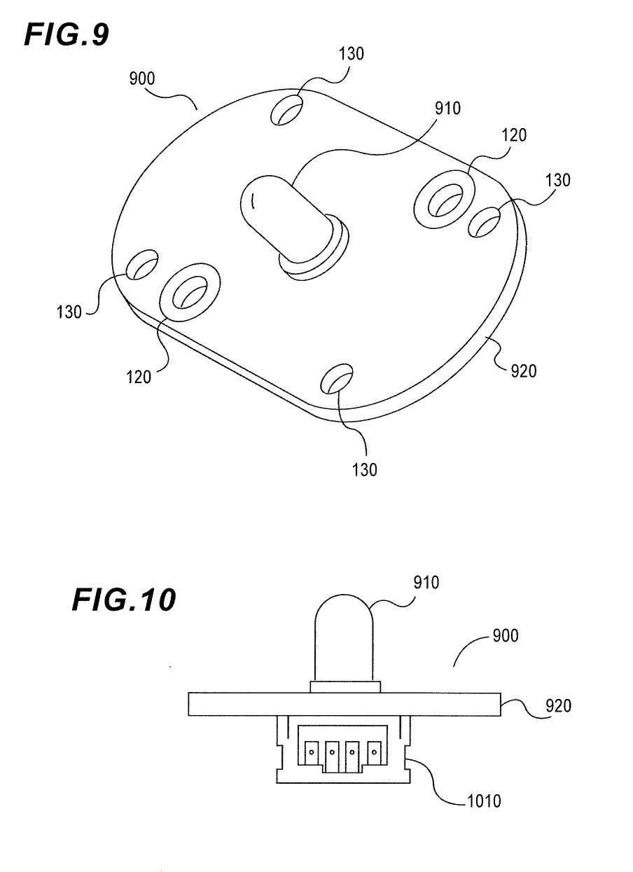

FIG. 9 is an exemplary embodiment of an elevated front perspective view of a multiple color LED lamp 900. In FIG. 9, an exemplary embodiment of LED 910, may be mounted on base 920. In one exemplary embodiment, an LED 910 may comprise, for example, an RBG LED, a frosted RGB LED (e.g., provides a larger viewing angle), a long RGB LED (e.g., but not limited to, 8.6 mm), a short RGB LED (e.g., but not limited to, 5.5 mm). In an exemplary embodiment, an LED 910 may vary in color which may allow for a single LED 910 to display at least any color in the visible spectrum. Additionally, in an exemplary embodiment, LED 910, may be extended by a spacer (not shown) which may increase the distance of LED 910 from base 920, and allow, for example, mounting or displaying of the LED Lamp 900 in material too thick for a lamp without a spacer.

FIG. 9 also depicts in an exemplary embodiment, base 920, as a rounded printed circuit board with glue holes 130 and screw holes 120. In an exemplary embodiment, the rounded base 920 may be mounted on soft material (e.g., but not limited to, curtains or fabric) (not shown) which may reduce the profile of the board 920 and may help prevent damaging the soft mounting material. Square boards with sharp edges may pierce through fabric after repeated folding and unfolding, though these features may be provided in alternative embodiments. In an exemplary embodiment, glue holes 130 may provide a method to mount base 920 using glue, tape, or other exemplary adhesive; glue holes 130 may provide better adhesion of base 140 to a mounting material. In an exemplary embodiment, screw holes 120 may provide a method to mount base 920 using screws or other exemplary fasteners to a mounting material. In an exemplary embodiment, screw holes 120 may provide grounding for the LED lamp 900. In an exemplary embodiment, base 920, may have no electrical conductivity on the surface facing the mounting material which may allow mounting to metal or other conductive surfaces without shorting. In an exemplary embodiment, in situations where the typical green circuit board color is not desirable, base 920 may have a black solder mask or other solder mask color as needed to match the mounted material or for other color requirements.

FIG. 10 is an exemplary embodiment of a side view of a multiple color LED lamp 900. In FIG. 2, in an exemplary embodiment, an LED 910 and one mini plug-in connector 1010 are shown mounted to base 920. In an exemplary embodiment, two mini plug-in connectors 1010 may be mounted to base 920. In an exemplary embodiment, the mini plug-in connector 1010 may be a commercial wire to board connector such as the Duraclik™, Mini Mi II™, or C-Grid III™ from Molex®. In an exemplary embodiment, a strain relief tie down may provide additional wire support through the use of cable ties (not shown).

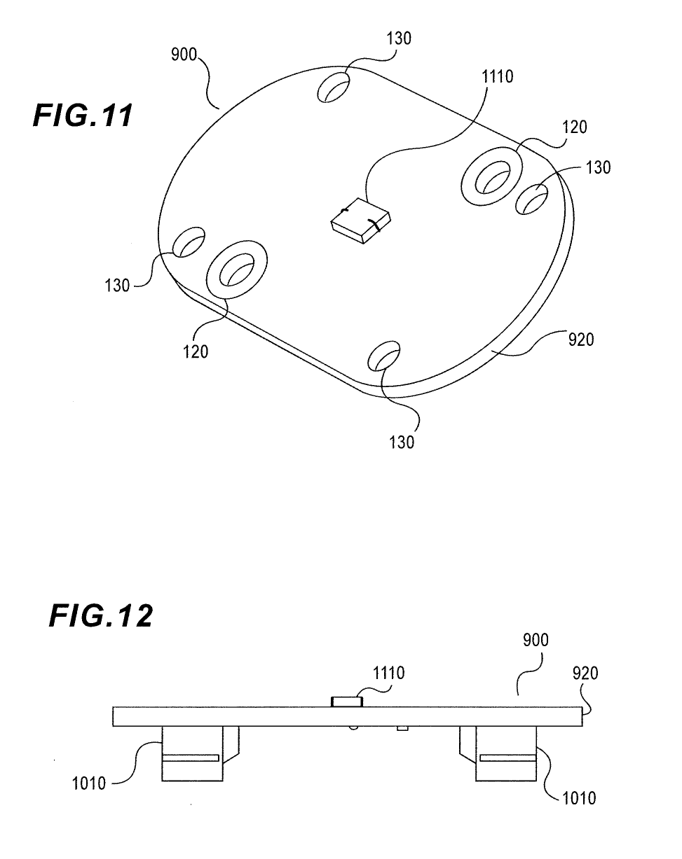

FIG. 11 is an exemplary embodiment of an elevated front prospective view of a multiple color LED lamp 900 where the LED may be a surface mounted device 1110. In one exemplary embodiment, an LED 1110 may use surface-mount technology to mount base 920. In FIG. 11, an exemplary embodiment of LED 1110 is depicted that may use different lenses such as those depicted in the exemplary embodiments of FIGS. 17-21.

FIG. 12 is an exemplary embodiment of a side view of a multiple color LED lamp 900 where the LED is a surface mounted device 1110. In FIG. 12, in an exemplary embodiment, two mini plug-in connectors 1010 are shown. In an exemplary embodiment, the mini plug-in connectors 1010, may allow an easy method for quickly coupling multiple LED lamps 900 to a power source and color controller.

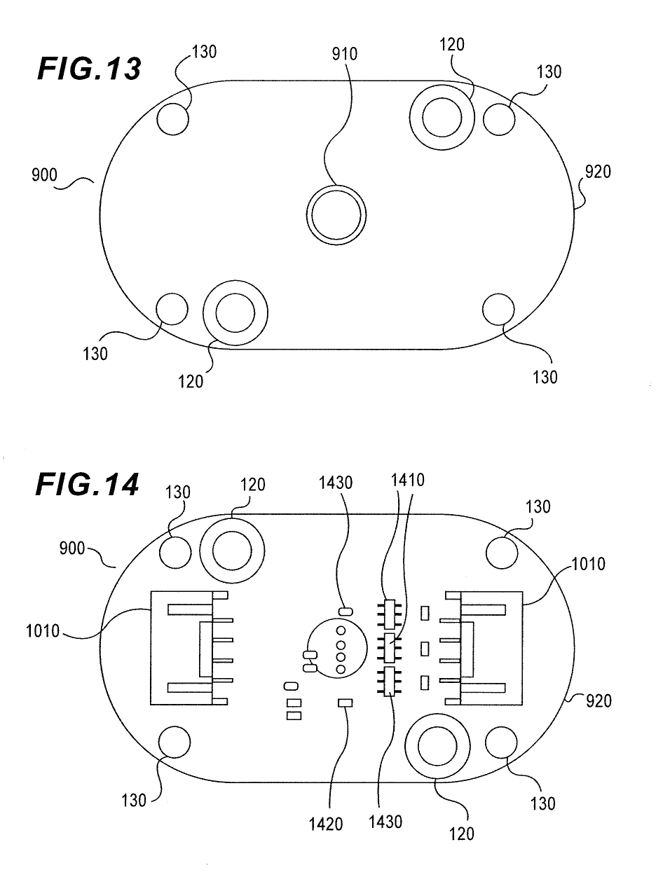

FIG. 13 is an exemplary embodiment of a top view of a multiple color LED lamp 900. In FIG. 13, exemplary embodiments of LED 910, base 920, screw holes 120, and glue holes 130 are shown.

FIG. 14 is an exemplary embodiment of a bottom view of a multiple color LED lamp 900. In FIG. 14, exemplary embodiments of mini plug-in connectors 1010, integrated circuits 1410, diodes 1420, and resistors 1430, may be mounted to base 920, which includes screw holes 120 and glue holes 130. In an exemplary embodiment, integrated circuits 630, diodes 620, and resistors 610, may protect the LED lamp 100 by providing constant current control in the event of a current or voltage spike, may prevent LED burnout if the polarity of the voltage is reversed, and may provide control for adjusting the color of LED 910.

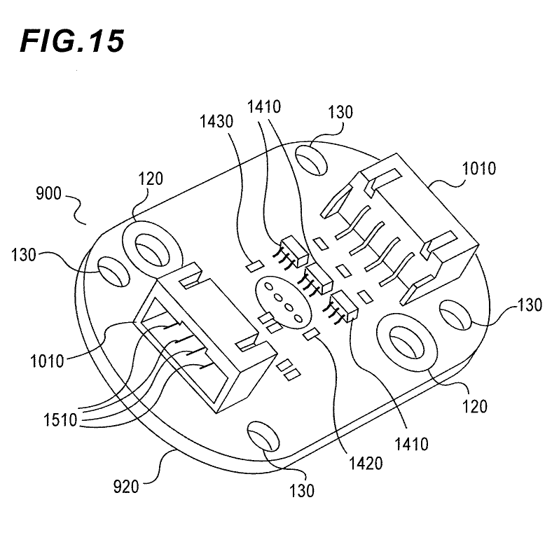

FIG. 15 is an exemplary embodiment of an elevated bottom view of a multiple color LED lamp 900. In FIG. 15, exemplary embodiments of mini plug-in connectors 1010, integrated circuits 1410, diodes 1420, and resistors 1430, may be mounted to base 920, which includes screw holes 120 and glue holes 130. In an exemplary embodiment, an electrical connection may be formed by connecting the male pins 1510 of mini plug-in connector 1010 to a female connector (not shown) (e.g., but not limited to, two-piece pin and socket interconnection) providing an electrical connection and may include color control to LED lamp 900. In an exemplary embodiment, the electrical connectors 1510 may have simple positive and negative connections or they may have more complicated connections such as for ground, red, green, blue, and red. In an exemplary embodiment, mini plug-in connector 1010 may have four male pins 1510, three of the pins may be neutral and one may carry current or alternatively, three may carry current and one may be neutral. In an exemplary embodiment, LED lamp 900 may have either anode or cathode versions or both.

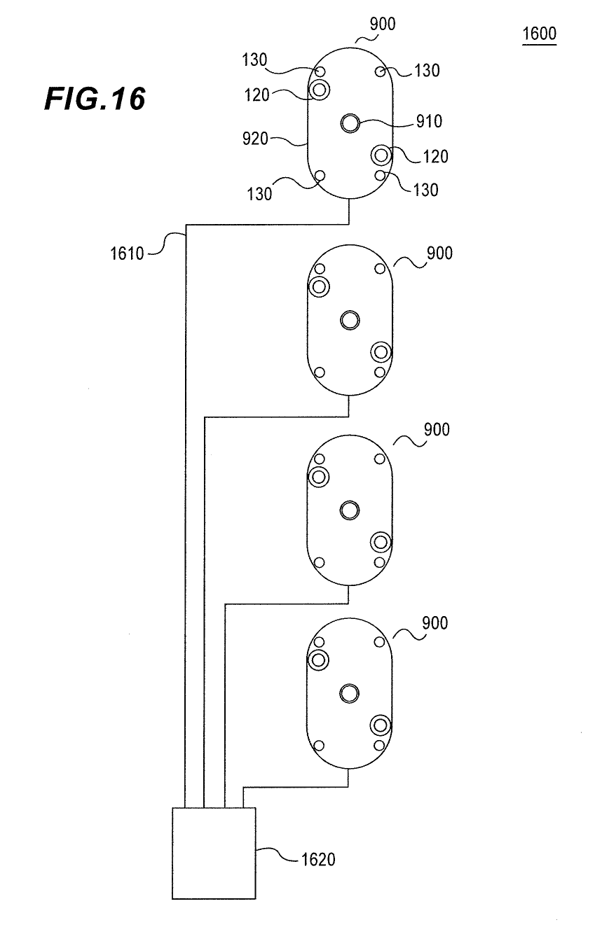

FIG. 16 illustrates an exemplary embodiment of an LED lamp string 1500 which incorporates two or more of the aforementioned LED lamps 900 with a random spacing therebetween coupled via conductor wires 1610 with power source and color control 1620. In FIG. 16, in an exemplary embodiment, the adjustable spacing between the LED lamps 900 can be set based on a user specification or input. In an exemplary embodiment, LED lamp 900 may connect to the conductor wires 1610 using mini plug-in connector 1010 or other connector (e.g., but not limited to, an IDC connector). In an exemplary embodiment, each LED lamp 900 may be directly coupled to the power supply and color controller through wires 1610 (e.g., but not limited to, 18 AWG stranded wires on 2.54 mm [0.100″] center lines) in for example, a hub and spoke distribution. In another exemplary embodiment, LED lamps 900 may be connected together in series. In an exemplary embodiment, the LED lamp 900 may contain two mini plug-in connectors 1010, one mini plug-in connector 1010, may be used as the input from a power source and color control 1620 and the other mini plug-in connector 1010, and/or may connect to a mini plug-in connector on another LED lamp 900 and thereby provide power and color control. In an exemplary embodiment, an LED lamp string 1600 may be manufactured by a method of assembling a plurality of LED lamps 900 with one or more wires 1610 affixed therebetween through an IDC, a mini plug-in connector 1010, other connectors, or a combination of various connectors.

FIG. 17 is a exemplary embodiment of a star shaped lens 1700 which may be affixed to surface mounted LED such as depicted in FIG. 3, as item 310, and/or in FIG. 1, as item 1110. In an exemplary embodiment, affixing lens 1700 to a surface mounted LED (310, 1110) may cause the light to appear in a star pattern.

FIG. 18 is a exemplary embodiment of a circle shaped lens 1800 which may be affixed to surface mounted LED such as depicted in FIG. 3, as item 310, and/or in FIG. 11, as item 1110. In an exemplary embodiment, affixing lens 1800 to a surface mounted LED (310, 1110) may cause the light to appear in a circle pattern.

FIG. 19 is a exemplary embodiment of a triangle shaped lens 1900 which may be affixed to surface mounted LED such as depicted in FIG. 3 as item 310, and/or in FIG. 11, as item 1110. In an exemplary embodiment, affixing lens 1900 to a surface mounted LED (310, 1110) may cause the light to appear in a triangle pattern.

FIG. 20 is a exemplary embodiment of a square shaped lens 2000 which may be affixed to surface mounted LED such as depicted in FIG. 3, as item 310, and/or in FIG. 11, as item 1110. In an exemplary embodiment, affixing lens 2000 to a surface mounted LED (310, 1110) may cause the emitted light to appear in a square pattern.

FIG. 21 is a exemplary embodiment of a bullet shaped lens 2100 which may be affixed to surface mounted LED such as depicted in FIG. 3, as item 310, and/or on FIG. 11, as item 1110. In an exemplary embodiment, affixing lens 2100 to a surface mounted LED (310, 1110) may cause the LED (310, 1110) to appear in a bullet shape. In an exemplary embodiment 2100 attached to a surface mounted LED (310, 1110) may replicate the traditional LED shape so that a surface mounted LED (310, 1110) may be used where the traditional LED shape is required.

The embodiments of FIGS. 17-21 are provided merely as exemplary embodiments of simple shapes. In other exemplary embodiments, one or more surface mounted LED lenses may be formed in any shape, character, or depiction.

The present invention has been explained above with reference to a number of exemplary embodiments. As will be apparent to the person skilled in the art, various modifications and amendments can be made without departing from the scope of the present invention, as defined in the appended claims.

What is claimed is:

1. A light emitting diode (LED) lamp, comprising:
a base;
an LED fixed to the base;
an integrated circuit providing constant current or voltage control to the LED; and
connectors for coupling one or more wires conducting electricity to the integrated circuit.

2. The light emitting diode (LED) lamp of claim 1, wherein the base further comprises one or more holes to facilitate mounting thereof to an external surface.

3. The light emitting diode (LED) lamp of claim 1, wherein the respective sides of the base are rounded in shape.

4. The light emitting diode (LED) lamp of claim 1, wherein one or more sides of the base comprise an electrically non-conductive material.

5. The light emitting diode (LED) lamp of claim 1, further comprising a spacer adjusting the distance of the LED from the base.

6. The light emitting diode (LED) lamp of claim 1, wherein the LED comprises at least one of:
a long LED;
a short LED;
a frosted LED;
a RBG LED; or
a single color LED.

7. The light emitting diode (LED) lamp of claim 1, wherein the LED comprises at least one of a through hole LED or a surface mounted LED.

8. The light emitting diode (LED) lamp of claim 1, wherein the LED comprises a surface mounted LED and a lens.

9. The light emitting diode (LED) lamp of claim 8, wherein the lens comprises the shape of at least one of:
a circle;
a star;
a triangle;
a square; or
a bullet.

10. The light emitting diode (LED) lamp of claim 2, wherein the one or more holes to facilitate mounting thereof to an external surface comprises at least one of a glue hole or a screw hole.

11. The light emitting diode (LED) lamp of claim 1, wherein the base further comprises one or more strain relief tie downs.

12. The light emitting diode (LED) lamp of claim 1, wherein the LED lamp comprises at least one of an anode RGB LED or a cathode RGB LED.

13. The light emitting diode (LED) lamp of claim 1, wherein the base further comprises one or more sides with a black solder mask.

14. The light emitting diode (LED) lamp of claim 1, wherein the base further comprises one or more sides with a user specified color.

15. The light emitting diode (LED) lamp of claim 1, wherein the connectors for coupling the one or more wires further comprise a groove designed to displace the insulation of a wire and provide an electrical connection.

16. The light emitting diode (LED) lamp of claim 1, wherein the connectors for coupling the one or more wires further comprise one or more pins which will accept an interface with one or more sockets and provide an electrical connection.

17. The light emitting diode (LED) lamp of claim 1, wherein a mounting position of the LED lamp on the one or more wires is determined based on an adjustable spacing between a plurality of the LED lamps.

18. The light emitting diode (LED) lamp of claim 1, wherein the base further comprises one or more sides of the base coated with an adhesive to facilitate mounting of the LED lamp to an external surface or material.

19. A light emitting diode (LED) lamp string with one or more integrally mounted LED lamps, the string comprising a plurality of LED lamps with adjustable spacing, each of the LED lamps being comprised of:
a base;
an LED fixed to the base;
an integrated circuit providing constant current or voltage control to the LED; and
connectors for coupling one or more wires conducting electricity to the integrated circuit.

20. The light emitting diode (LED) lamp string of claim 19, wherein the base further comprises one or more holes to facilitate mounting thereof to an external surface.

20. The light emitting diode (LED) lamp string of claim 19, wherein the adjustable spacing between the LED lamps is based on a user specification.

21. The light emitting diode (LED) lamp string of claim 19, wherein the base further comprises one or more strain relief tie downs.

22. The light emitting diode (LED) lamp string of claim 19, wherein one or more sides of the base are coated with an adhesive to facilitate mounting of the LED lamp to an external surface or material.

23. A method for assembling a plurality of light emitting diode (LED) lamps to form an LED lamp string comprising:
assembling a plurality of LED lamps with one or more wires affixed therebetween;
positioning each of the LED lamps on the one or more wires based on an adjustable spacing therebetween; and
wherein each of the LED lamps comprises a base with an affixed LED and an integrated circuit designed to regulate current or voltage to the LED.

24. The method of claim 23, wherein the adjustable spacing between the light emitting diode (LED) lamps is determined based on a user specification.
